(19) United States
(12) Patent Application Publication
(10) Pub. No.: US 2020/0240550 A1
(43) Pub. Date: Jul. 30, 2020

(54) HINGED CLAMPING BRACKET FOR AT LEAST ONE TUBULAR ARTICLE

(71) Applicant: AUTOTUBE AKTIEBOLAG, Varberg (SE)

(72) Inventors: Jan OLOFSSON, Varberg (SE); Cecilia LÖFGREN, Varberg (SE)

(73) Assignee: AUTOTUBE AKTIEBOLAG, Varberg (SE)

(21) Appl. No.: 16/845,732

(22) Filed: Apr. 10, 2020

Related U.S. Application Data
(63) Continuation of application No. 16/254,024, filed on Jan. 22, 2019.

(30) Foreign Application Priority Data
Jan. 22, 2018 (FR) 18/70055

(51) Int. Cl. F16L 3/10; F16L 3/237; F16L 3/223

(52) U.S. Cl. CPC F16L 3/1033; F16L 3/2235; F16L 3/237

(57) ABSTRACT

A hinged clamping bracket for at least one tubular article. The bracket for at least one tubular article includes lower and upper separable members which are complementarily shaped to define at least one cylindrical clamping housing for receiving the tubular article and a hinge pivotally connecting the members for relative rotating movement. More specifically, the lower and upper members include respectively lower and upper articulating portions each provided with a seat defining a substantially semi-cylindrical receiving space and forming respectively lower and upper articulating parts of the hinge, thereby forming a rotatable pivot assembly with the tubular article in the clamping bracket assembling position in which the two separable members are rotationally articulated about the tubular article acting as the pivot axis of the hinge.

This is a Continuation of application Ser. No. 16/254,024 filed Jan. 22, 2019, which claims priority to French Patent Application No. 18/70055 filed Jan. 22, 2018. The disclosure of the prior applications is hereby incorporated by reference herein in their entireties.

The invention relates to a hinged clamping bracket which holds at least one tubular article, for example a pipe through which a fluid flows, such as a pipe of a fuel system, brake system, cooling system or the like in an automobile or the like. More particularly, the invention relates to a clamping bracket which includes two articulated members able to enclose and retain one or more pipes.

More specifically, the invention concerns a clamping bracket comprising lower and upper members which include respectively lower or upper complementary shaped partial-cylindrical portions formed on inner faces facing each other.

In order to facilitate the positioning of the pipe (s) in the clamping bracket, it is known to connect both members of the clamping bracket with an axial extension hinge. In this way, the pipe is positioned in the semi-cylinder portion of the lower member of the clamping bracket and the upper member is then moved angularly to close the clamping bracket by overlapping the two semi-cylinder portions.

It is known, in particular from the publication of the European patent application EP 0 638 756 A1, a clamping bracket comprising a clamp body provided with a clamping housing of at least one tube. The clamping bracket consists of two shells made of a single piece, e. g. plastic, and connected to each other by a joint fold. This joint fold is formed by a thinning of plastic material in the fold area. In use, the clamping bracket clamps the pipe, e. g. a pipe from a fuel circuit, in the clamping area of the pipe formed by the angular displacement of the two hinged shells in contact with each other.

This clamping bracket has the advantage of being very simple since it consists of a single piece. However, this clamping bracket is subjected to repeated stresses on the fold joint in operation when opening and closing the clamping bracket which may eventually weaken the fold joint and lead to its tearing or even its partial or total breakage.

In particular, the invention thus aims to provide a clamping bracket that does not present the above-mentioned disadvantages of the prior art document. The invention is intended to provide a clamping bracket with a robustly designed hinge, while ensuring optimal tightening of the pipe (s).

To this end, one subject of the invention is a clamping bracket for at least one tubular article comprising:
lower and upper separable members which are complementarily shaped to define at least one cylindrical clamping housing for receiving the tubular article, and
a hinge pivotally connecting the lower and upper members for relative rotating movement between an open position in which the lower and upper members extend co-axially substantially in end-to-end relationship and a closed position in which the upper member is rotationally displaced with respect to the lower member out of the end-to-end relationship,
   characterized in that the lower and upper members comprise respectively lower and upper articulating portions each provided with a seat defining a substantially semi-cylindrical receiving space and in that the lower and upper articulating portions are respectively lower and upper articulating parts of the hinge, thereby forming a rotatable pivot assembly with the tubular article in the clamping bracket assembling position in which the two separable members are rotationally articulated about the tubular article acting as the pivot axis of the hinge.

The configuration proposed herein has a number of advantages. Because the two members are connected by a hinge which is formed by specific clamping portions around the pipes, the hinge is particularly robust. The elements of the hinge will not suffer from deterioration over time because of repeated stresses.

Moreover, this arrangement is particularly advantageous to facilitate the positioning of the pipe into its cylindrical housing while ensuring a strong clamping force. Preferentially, both or at least one of the plastic members are clipped on to the first pipe. The design is so done that the pipe is forming both the hinge and holding both members in correct place.

The second member can then easy be closed around the second pipe before securing the assembly with for example a center bolt keeping the brackets both closed firmly and attached to a chassis or an engine block.

Preferentially, one or both members can have a metallic compression limiter for receiving a fastening element such as a bolt. The metallic compression limiter can have a cylindrical or oval shape. This compression limiter enables to avoid high stresses or compression set in the plastic bracket during fixation by center bolt to a chassis or an engine block. This enables the fastening element to be firmly tightened without overly compressing the plastic members.

In accordance with another optional feature of the invention, the two articulating portions are arranged to be joined by an inter-engagement allowing rotation around a virtual pivot axis.

In accordance with another optional feature of the invention, the seat of one of the articulating portions is formed by a curved hinge tab and the seat of the articulating portions is formed by at least two fork-shaped curved branches, the hinge tab being configured to engage between the two branches.

In accordance with another optional feature of the invention, the hinge tab and each of the branches have a cross-section having a general “C” shape, the hinge tab being inserted between the two branches so that the “C”'s substantially overlap according to the same axial direction in the end-to-end disposition.

In accordance with another optional feature of the invention, the two members are of mutually identical cross-sectional shape and are arranged in head-to-foot relationship in the closed position.

In accordance with another optional feature of the invention, the seat of each articulating portion is formed by fork-shaped curved branches, the branches of the lower fork are alternatingly arranged with respect to the branches of the upper fork.

In accordance with another optional feature of the invention, the lower and upper members comprise lower and upper fastening portions provided with lower and upper mutually abutment surfaces in the closed position.

In accordance with another optional feature of the invention, the lower and upper fastening portions are each provided with abutment surfaces which are complementarily profiled and constitute locking surfaces preventing mutual rotation between the members in the closed position.

In accordance with another optional feature of the invention, each of the fastening portions comprises running through it a hole for a fastening element such as screw for clamping the members together around the tubular article.

In accordance with another optional feature of the invention, the fastening portion extends between two cylindrical housings for receiving two pipes.

In accordance with another optional feature of the invention, the lower and upper members comprise respectively lower and upper receiving portions each provided with another seat defining a substantially semi-cylindrical receiving space for receiving another tubular article.

In accordance with another optional feature of the invention, the members are made of a plastic material.

In accordance with another optional feature of the invention, the two said articulating portions are elastically deformable for being mounted onto the tubular article by clipping.

In accordance with another optional feature of the invention, comprising at least one breakable bridge carried by one of the members and projecting towards the other of the members in order to temporarily fix the bracket in the open position.

A further object of the invention concerns an assembly comprising a clamping bracket and at least one tubular article, said clamping bracket being in accordance with the invention, each of the said articulating portions is adapted to clip around the tubular article.

A further object of the invention is to propose a method of assembling a clamping bracket and a tubular article, of an assembly according to the invention, comprising the following steps of:
positioning the lower or upper members in an end-to-end arrangement so that the semi-cylindrical seats are overlapped according to an axis,
clipping the article into the lower articulating portion and into the upper articulating portion of the bracket,
moving in rotation the upper member around the tubular article to close the clamping bracket.

Further characteristics and advantages of the invention will become apparent from the detailed description which follows, given with reference to the appended drawings, provided purely by way of non-limiting example in which:

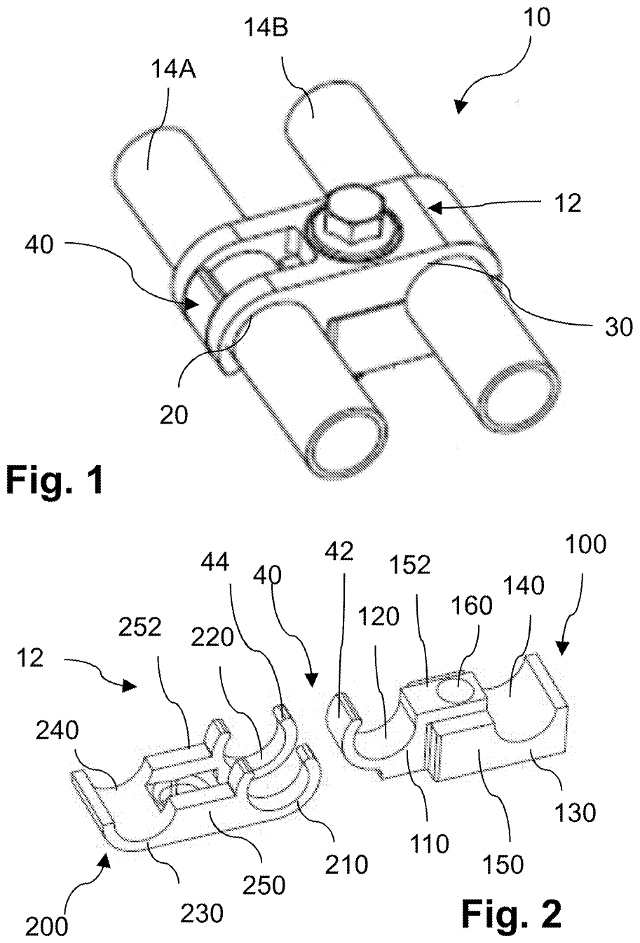

FIG. 1 represents a perspective view of an assembly according to one aspect of the present invention;

FIG. 2 represents a perspective view of lower and upper separable members of the assembly of FIG. 1;

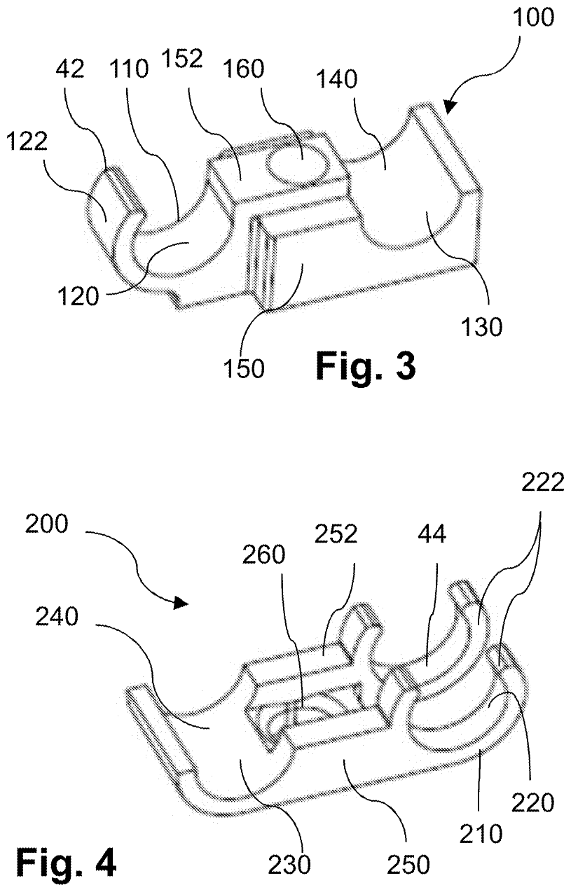

FIG. 3 and FIG. 4 represent respectively detailed view of lower and upper separable members of the FIG. 2;

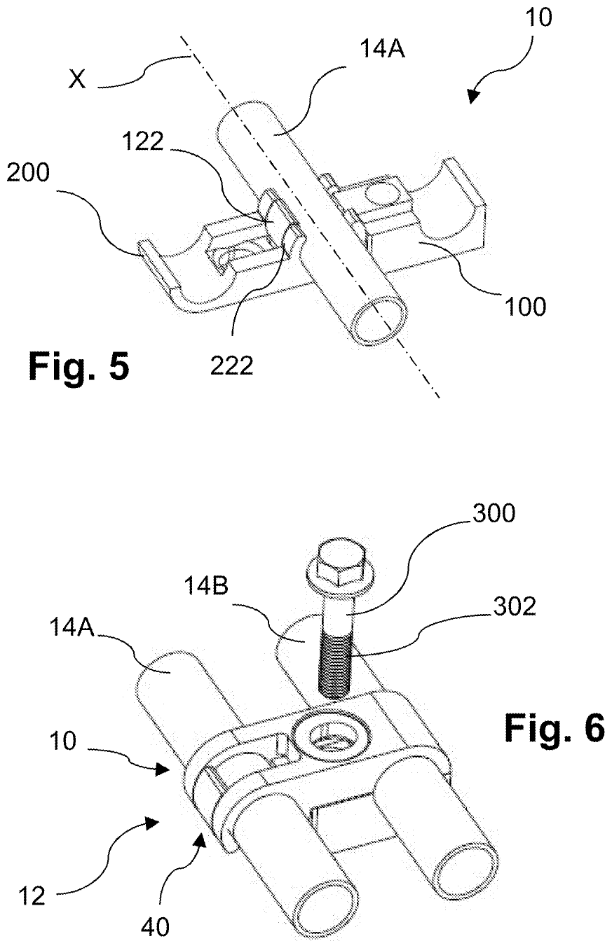

FIG. 5 and FIG. 6 represent steps of the assembling method of the assembly illustrated by FIG. 1;

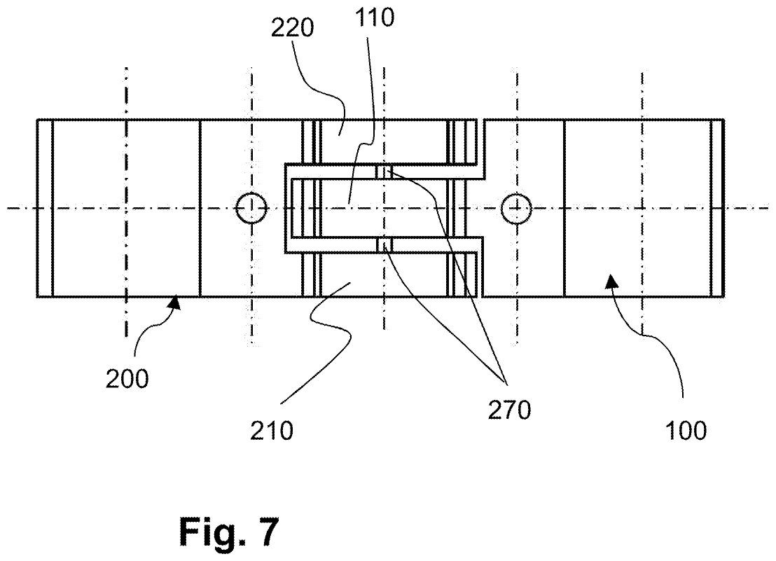

FIG. 7 represents a top view of an assembly according to another embodiment of the invention.

FIG. 1 depicts an assembly according to a first embodiment of the invention and denoted by the overall reference 10. With reference to FIG. 1, the assembly 10 comprises a clamping bracket 12. The clamp is for example a clamp 12 which holds tubular articles, such as fuel pipes or brake pipes in an automobile. In this example, the clamp 12 is intended to hold cooling pipes of an automobile.

With reference now to FIG. 2, the clamping bracket 12 comprises lower and upper members 100 and 200. The members 100, 200, in this particular instance, are able to be detached relative to one another. According to the invention, the lower and upper members 100, 200 are complementarily shaped to delimit together at least one cylindrical clamping area or housing 20 for at least one tubular article 14A. In this example, the first lower and upper members 100 and 200 sandwich two pipes 14A, 14B and delimit together two cylindrical clamping areas or housings 20 and 30 for each of the two pipes 14A, 14B (FIG. 1).

As illustrated in detailed in FIG. 2, the lower member 100 comprises a lower articulating portion 110 comprising a lower seat 120 defining a substantially semi-cylindrical receiving space. The upper member 200 also comprises an upper articulating portion 210 comprising an upper seat 220 defining a substantially semi-cylindrical receiving space. These partial-cylindrical seats 120 and 220 are complimentary shaped to form the cylindrical clamping housing 20 for receiving the pipe 14A.

In the present description, the lower member 100 and the upper member 200 comprise respectively lower 130 and upper 230 receiving portions provided respectively with lower 140 and upper seats 240 defining together another housing 30 for receiving the other pipe 14B.

According to the invention, the clamping bracket 12 also comprises a hinge 40 pivotally connecting the lower and upper members 100, 200 for relative rotating movement between an open position in which the lower and upper members 100, 200 extend co-axially substantially in end-to-end relationship (FIG. 5) and a closed position in which the upper member 200 is rotatably displaced with respect to the lower member 100 out of the end-to-end relationship (FIG. 6).

More specifically, the lower 110 and upper 210 articulating portions are respectively lower and upper articulating separable parts of the hinge 40, thereby forming a rotatable pivot assembly with the tubular article 14A in the clamping bracket assembling position. In this position, the two separable members 100 and 200 are rotationally articulated around the tubular article 14A which acts as the pivot axis of the hinge 40.

As illustrated in FIG. 5, the two members 100, 200 are able to move one relative to the other between an open position for inserting at least one pipe 14A into the partial cylindrical seat 120 of the lower articulating portion 110 and a closed position for holding the pipe 14A in the cylindrical housing 20.

Advantageously, the two articulating portions 110, 210 are arranged to be detachably joined by inter-engagement, while allowing relative rotation around a virtual pivot axis X.

In this particular instance, the seat 120 of the lower articulating portion 110 is formed by a curved hinge tab 122 and the seat 220 of the upper articulating portion 210 is formed by at least two fork-shaped curved branches 222. The hinge tab 122 is configured to be inter-engaged between the two branches 222.

As depicted in FIG. 5, the hinge tab 122 is for example arranged to be frictionally received within said hinge fork 222. In operation, the two members 100, 200 are connected one to another in an inter-engaged relation when said hinge tab 122 and said hinge fork 222 are brought into engagement.

For preference, the hinge tab 122 and each of the branches 222 have a cross-section having a general “C” shape or more generally a shape of a segment of a circle. In operation, the hinge tab 122 is inserted between the two branches 222 so that the “C”'s substantially overlap according to the same axial direction X in the end-to-end disposition (FIG. 5).

Advantageously, the two said articulating portions 110, 210 are elastically deformable for being mounted onto the tubular article 14A by clipping. Each of the said articulating portions 110, 210 is thus adapted to clip around the tubular article 14.

In the example, lower and upper members 100, 200 respectively comprise lower 150 and upper 250 fastening portions each provided with lower 152 and upper 252 mutually abutment surfaces, the abutment surfaces 152, 252 being arranged so that they abut against one another when the bracket is in the closed configuration.

Preferentially, the fastening portions 150, 250 are each provided with abutment surfaces 152, 252 which are complementarily profiled and constitute locking surfaces preventing mutual rotation between the members 100, 200 in the closed configuration of the bracket 12. This prevents also axial movement along X-axis keeping the upper 200 and lower 100 members securely interlocked.

Preferentially, as illustrated in FIGS. 3, 4 and 6, the fastening portions 150, 250 delimit together a hole 160, 260 running through each of the fastening portions 150, 250, for receiving a fastening element 300 such as screw for clamping the members 100, 200 together around the tubular article 14A. The fastening element 300 is in this example a screw comprising a threaded portion 302, the threaded portion 302 can be brought into engagement with an inner threaded part of the hole 160, 260 of the clamping bracket 12 or, as illustrated in the present description, can be brought into engagement with an inner threaded part of another structure support such as a chassis or an engine block.

Preferentially, the members 100, 200 are made of a plastic material. For example, the members 100, 200 are made by overmolding. This “overmolding” operation consists of placing a first member previously made in another injection mould in an injection mould and then injecting plastic to form a second member on the top of or around the first member. This makes it possible to form a detachable connection between the two members, since the first member made in an anterior injection phase is already cured when the next plastic injection phase of the second member is carried out. Such an overmolding process is already known for example for the production of plastic chains or certain hinged toy figures such as for example the commercial Playmobil® toy figures in plastic.

The two said articulating portions 110, 210 are for example elastically deformable for being mounted onto the tubular article by clipping.

Preferentially, at least one of the members 100, 200 comprises a metallic compression limiter for receiving the fastening element 300. The compression limiter comprises for example a sleeve with a general cylindrical or oval shape. This prevents center bolt from crushing plastic or from causing premature wear and tear over time.

In this example, the two fastening portions 150, 250 fully correspond to one another and may include, for example, clip means for holding the two members in position relative to each other around the tubular article before fixing the whole assembly to an external support structure, for example a chassis or an engine block by means of the fixing element 300.

In an alternative, the two fastening portions 150, 250 may fully correspond to one another to allow the two members 100, 200 to be fastened by the threaded portion 302 of the screw 300 in a threaded portion of the hole 160, 260 to make it possible for the members 100, 200 to be held together solely by a screw.

As illustrated, the fastening portion 150, 250 extends between the two cylindrical housings 20, 30 for receiving the two pipes 14A, 14B.

As an alternative of the invention not illustrated, the bracket 12 comprises two members 100, 200 which are of mutually identical cross-sectional shape. The members 100, 200 may therefore advantageously be produced using a single molding tool, e.g. by plastic injection.

In this alternative, the members 100, 200 are arranged in head-to-foot relationship in the assembled configuration of the bracket. Preferentially, the two members 100, 200 have inside a pair of cylindrical passages arranged at mutual spacing to accommodate the pipes and between the passages, each member has running through it a hole for a fastening element such as a screw for clamping the members together around the pipes.

For example, each member 100, 200 has profiled surfaces portions, designed as fastening portion, which are mutually complementary so that they will abut against one another in the closed configuration of the bracket. More specifically, a central surface portion of the surface fastening portion constitutes a locking surface which prevents mutual rotation between the members in the closed configuration of the bracket 12. In this alternative, the seat of each articulating portion 110, 210 is formed by fork-shaped curved branches, the branches of the lower fork are disposed for example in an alternating arrangement with respect to the branches of the upper fork.

In another embodiment of the invention not illustrated in this application, each of the two lower and upper articulation portions comprises one side abutment surface, the abutment surfaces being arranged to form together an abutment region in the open position by axially moving of the two side abutment surfaces towards each other without any inter-engagement. In the open configuration of the bracket, the two members 100, 200 are arranged side-by-side but are not joined together.

The two members are joined to one another only by the two fastening portions in the closed configuration of the bracket. Preferentially in this embodiment, the two members are of mutually identical cross-sectional shape. The two articulating portions have each a “C” shape cross-section so that the “C”'s substantially overlap according to the same axial direction in the end-to-end disposition and wherein the two members are arranged in head-to-foot relationship in the closed configuration of the bracket.

In another embodiment of the invention illustrated in FIG. 7, the bracket 12 comprises positioning means 270 which are breakable. For example, as illustrated in FIG. 7, the positioning means 270 comprises at least one lug or bridge, carried by one of the members 110, 210, and projecting towards the other of the members 210, 110. As it can been seen in FIG. 7, the two members 110, 210 are held securely in the open position by means of the breakable lugs 270. After rupture of said positioning means 270, the two members 110, 210 are free to move from the open position to the closed position.

A preferred embodiment of the assembly method according to the invention will now be described with reference to the figures. FIG. 2 shows in perspective the clamping bracket and this figure serves as a starting point in the assembly method.

Initially, the two members 100, 200 of the bracket are disassembled and are completely independent of one another, as illustrated in FIG. 2.

At first step, the two members 100, 200 are arranged in an end-to-end arrangement in which the semi-cylindrical seats 120, 220 are overlapped according to the axis X to enable the positioning of the first pipe 14A. The two members 100, 200 are brought into engagement by engaging the hinge tab 122 of the lower articulating portion 110 into the hinge fork 222 of the upper articulating portion 210.

At the second step, the lower articulating portion 110 and the upper articulation portion 210 are attached to the first pipe 14A. The positioning of the first pipe 14A consists in clipping the pipe 14A into both semi-cylindrical seats 120, 220 of the members 100, 200. The positioning of the second pipe 14B consists in inserting the pipe 14B into the receiving semi-cylindrical seat 140 or may consist also in clipping the pipe 14B into the seat 140. In a third step, the upper member 200 is moving in rotation around the pipe 14A to close the clamping bracket 12.

In a final step, a bolt 300 is inserted from above into the through hole and the end of the bolt is then for example screwed into the hole to connect the pair of members 100, 200 together.

Thus, there has been shown and described a novel clamping bracket for a snap-fit fastening of pipes. Many changes, modifications, variations and other uses and applications of the subject invention will, however, become apparent to those skilled in the art after considering this specification and its accompanying drawings, which disclose a preferred embodiment thereof.

All changes, modifications, variations and other uses and applications which do not depart from the teachings herein are deemed to be covered by this patent, which is limited only by the claims which follow as interpreted in light of the foregoing description. In the example described, the pipes take the form of fuel pipes, but the invention may be applied with advantage to all types of lines, e.g. other kinds of pipelines, and to electrical lines or combination of different type of lines. The example described refers to two pipes but the invention may also be applied where a different number of lines are to be fastened.

1. A clamping bracket for at least one tubular article comprising:
lower and upper separable members which are complementarily shaped to define at least one cylindrical clamping housing for receiving the tubular article, and
a hinge pivotally connecting the lower and upper members for relative rotating movement between an open position in which the lower and upper members extend co-axially substantially in end-to-end relationship and a closed position in which the upper member is rotationally displaced with respect to the lower member out of the end-to-end relationship,
wherein the lower and upper members comprise respectively lower and upper articulating portions each provided with a seat defining a substantially semi-cylindrical receiving space and in that the lower and upper articulating portions form respectively lower and upper articulating parts of the hinge, thereby forming a rotatable pivot assembly with the tubular article in the clamping bracket assembling position in which the two separable members are rotationally articulated about the tubular article acting as the pivot axis of the hinge.

2. The clamping bracket according to claim 1, wherein the two articulating portions are arranged to be joined by an inter-engagement allowing rotation around a virtual pivot axis.

3. The clamping bracket according to claim 1, wherein the seat of one of the articulating portions is formed by a curved hinge tab and the seat of the articulating portions is formed by at least two fork-shaped curved branches, the hinge tab being configured to engage between the two branches.

4. The clamping bracket according to claim 3, wherein the hinge tab (and each of the branches have a cross-section having a general “C” shape, the hinge tab being inserted between the two branches so that the “C”'s substantially overlap according to the same axial direction (X) in the end-to-end disposition.

5. The clamping bracket according to claim 1, wherein the two members are of mutually identical cross-sectional shape and are arranged in head-to-foot relationship in the closed position.

6. The clamping bracket according to claim 5, wherein the seat of each articulating portion is formed by fork-shaped curved branches, the branches of the lower fork are alternatingly arranged with respect to the branches of the upper fork.

7. The clamping bracket according to claim 1, wherein the lower and upper members comprise lower and upper fastening portions provided with lower and upper mutually abutment surfaces in the closed position.

8. The clamping bracket according to claim 7, wherein the lower and upper fastening portions are each provided with abutment surfaces which are complementarily profiled and constitute locking surfaces preventing mutual rotation and/or axial movement between the members in the closed position.

9. The clamping bracket according to claim 7, wherein each of the fastening portions comprises running through it a hole for a fastening element such as screw for clamping the members together around the tubular article.

10. The clamping bracket according to claim 7, wherein the fastening portion extends between two cylindrical housings for receiving at least two pipes.

11. The clamping bracket according to claim 1, wherein the lower and upper members comprise respectively lower and upper receiving portions each provided with another seat defining a substantially semi-cylindrical receiving space for receiving another tubular article.

12. The clamping bracket according to claim 1, wherein the members are made essentially of a plastic material.

13. The clamping bracket according to claim 12, wherein at least one of the members comprises a metallic compression limiter for receiving a fastening element.

14. The clamping bracket according to claim 1, wherein the two said articulating portions are elastically deformable for being mounted onto the tubular article by clipping.

15. The clamping bracket according to claim 1, comprising at least one breakable bridge carried by one of the members and projecting towards the other of the members in order to temporarily fix the bracket in the open position.

16. An assembly comprising a clamping bracket and at least one tubular article, wherein, said clamping bracket being in accordance with claim 1, each of the said articulating portions is adapted to clip around the tubular article.

17. A method of assembling a clamping bracket and a tubular article, of an assembly according to claim 16, comprising the following steps of:
positioning the lower or upper members in an end-to-end arrangement so that the semi-cylindrical seats are overlapped according to an axis,
clipping the article into the lower articulating portion and into the upper articulating portion of the bracket,
moving in rotation the upper member around the tubular article to close the clamping bracket.
